(19) United States
(12) Patent Application Publication
(10) Pub. No.: US 2018/0197104 A1
(43) Pub. Date: Jul. 12, 2018

(54) USING AN ACTION-AUGMENTED DYNAMIC KNOWLEDGE GRAPH FOR DIALOG MANAGEMENT

(71) Applicant: Microsoft Technology Licensing, LLC, Redmond, WA (US)

(72) Inventors: Marius Alexandru Marin, Seattle, WA (US); Paul Anthony Crook, Bellevue, WA (US)

(73) Assignee: Microsoft Technology Licensing, LLC, Redmond, WA (US)

(21) Appl. No.: 15/400,014

(22) Filed: Jan. 6, 2017

(51) Int. Cl. G06N 99/00; G06N 3/00; G06F 17/30

(52) U.S. Cl. CPC G06N 99/005; G06F 17/30979; G06F 17/30958; G06N 3/006

(57) ABSTRACT

Described herein is a personal digital agent system that interacts with a user in order to process various requests from the user. The personal digital agent system is associated with a dynamic knowledge graph that is tailored specifically for the user and is automatically updated when the personal digital agent interacts with the user.

### BACKGROUND

In current personal digital agent systems, interactions between a user and the personal digital agent system are typically modeled as a series of independent tasks. Each task is defined as the execution of a single, self-contained action on behalf of the user. Examples of tasks include: setting a reminder, sending an email, answering a question, returning search results for a specific query, or even entertaining the user by responding to conversational chatter in a plausibly-human way.

In these person digital agent systems, the state of each task is represented as a flat, or sometimes hierarchical, structure (e.g., a tree) containing nodes. Each node in the tree may represent an entity that is pertinent to the conversation. Relationships between the different nodes are represented as edges. However, only parent-child relationships are represented in the tree. Furthermore, carrying information between tasks is difficult due to each task requiring a different structure of the state to be represented.

It is with respect to these and other general considerations that embodiments have been described. Also, although relatively specific problems have been discussed, it should be understood that the embodiments should not be limited to solving the specific problems identified in the background.

### SUMMARY

This disclosure generally relates to personal digital agents and how to update a graph that stores conversational information between the personal digital agent and a user. More specifically, the present disclosure is directed to a dynamic knowledge graph that contains information accumulated by the personal digital agent during various conversation sessions with the user. The dynamic knowledge graph is updated with information as soon as the user provides it.

Accordingly, aspects of the present disclosure are directed to a system comprising a processing unit and a memory. The memory stores computer executable instructions which, when executed by the processing unit, causes the system to perform a method. The method includes receiving input and parsing the input to determine an action request contained in the input. A dynamic knowledge graph is accessed to determine whether an action and an entity stored in the dynamic knowledge graph are associated with the action request. When it is determined that the dynamic knowledge graph includes an action and an entity that is associated with the action request, the action is executed on the entity. When it is determined that the dynamic knowledge graph does not include an action and an entity that is associated with the action request, additional input associated with the action request is requested. Once received, the dynamic knowledge graph is automatically updated with the additional input.

Also disclosed is a method for determining an intent of input received in a personal digital agent system. This method includes receiving an input and determining an action request associated with the input. A dynamic knowledge graph is queried to determine whether the action request can be fully executed with the knowledge contained in the dynamic knowledge graph. When it is determined that the action request cannot be fully executed with the knowledge contained in the dynamic knowledge graph: additional input is requested, the additional input is automatically input into the dynamic knowledge graph and the action request is executed using the additional input.

Also disclosed is a computer-readable storage medium storing computer executable instructions which, when executed by a processing unit, causes the processing unit to perform a method for updating a dynamic knowledge graph. This method includes receiving an input and determining an intent of the input. The dynamic knowledge graph is then queried to determine whether one or more actions within the dynamic knowledge graph can be executed to satisfy the intent of the input. When it is determined that the dynamic knowledge graph does not include one or more actions to satisfy the intent of the input, additional input is requested and received. The dynamic knowledge graph is then automatically updated with the additional input.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example personal digital agent system that incorporates or is otherwise associated with a dynamic knowledge graph according to an example embodiment.

FIG. 2 illustrates example components of a hypothesis processor that may be associated with a personal digital agent system according to an example embodiment.

FIG. 3 illustrates a method for updating a dynamic knowledge graph according to an example embodiment.

FIG. 4 is a block diagram illustrating example physical components of a computing device with which aspects of the disclosure may be practiced.

FIGS. 5A and 5B are simplified block diagrams of a mobile computing device with which aspects of the present disclosure may be practiced.

FIG. 6 is a simplified block diagram of a distributed computing system in which aspects of the present disclosure may be practiced.

FIG. 7 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Embodiments described herein are directed to a personal digital agent system that uses a dynamic knowledge graph to interact with a user. As will be described below, the personal digital agent system is configured to tag spoken or written user input to create one or more initial hypotheses about the user's desired outcome of a given interaction with the personal digital agent system. The tagged user input is then mapped to actions and data entities contained in the dynamic knowledge graph. The personal digital agent system may also map tactile user input to various actions and data entities in the dynamic knowledge graph.

The personal digital agent system is also configured to search the dynamic knowledge graph for suitable chains of actions that map between existing data entities and/or actions in the dynamic knowledge graph and action requests contained in input received from a user. The personal digital agent system also selects which actions in the dynamic knowledge graph to execute and is also configured to compose or generate responses that are provided to the user. As part of this process, the system may select a hypothesis for the user's intent and provide an associated response that is communicated to the user.

The dynamic knowledge graph may be continually updated as the personal digital agent interacts with the user. For example, when a knowledge graph does not include information that is required to address a user request, the dynamic knowledge graph may be updated through discovery of relevant entities and actions from external knowledge sources. As used herein, a personal digital agent is an artificial intelligence entity that helps users perform different tasks. These tasks can include, but are not limited to, executing a transactional action (e.g., sending an email), providing correct information requested by the user (e.g., question answering systems, voice searching, etc.), providing entertainment to the user by conducting a conversation with the user (e.g., a chat bot) in which multiple turns are involved, and so on.

Although the examples described herein are related to a single user interacting with a single personal digital agent, the embodiments described herein are not so limited. The embodiments described herein may be used in a conversation between two or more parties in which a personal digital agent, or other artificial intelligence entity, is interjecting between the parties or is only visible to one of the users, in a conversation between two personal digital agents and a single user and so on.

To fulfill any single task, the personal digital agent system needs various pieces of information that it elicits from the user. For example, during any conversation with the user, the system keeps track of which pieces of information the user has provided and which pieces of information are missing. In order to do this, the personal digital agent system utilizes a dynamic knowledge graph that is automatically updated based on various conversation turns with the user. For example, the dynamic knowledge graph is updated whenever a user provides additional input. This input may then be used during later conversations—even if the conversation lasts or occurs over many days or weeks.

Using a dynamic knowledge graph such as the one described sets the instant disclosure apart from previous solutions. As described above, traditional personal digital assistant systems track the state for each task independently. However, this solution only works well when users complete tasks independently of one another and in sequence. Another drawback to these systems is that there is little information that can be reused and/or shared across different tasks.

However, unlike previous solutions, the embodiments described herein enable different tasks or actions stored in the dynamic knowledge graph to reuse information that was collected in previous conversations and other interactions with the user. In some instances, the information may be shared among different tasks. For example, the tasks or actions of booking an airplane trip, renting a hotel room, and hiring ground transportation may all share information, such as the dates and location of travel. Accordingly the dynamic knowledge graph is able to indicate which data from different tasks may be reused and/or shared.

In order to accomplish the above, the dynamic knowledge graph described herein represents data entities (e.g., data on which tasks or actions can be executed on) in a task-independent manner. Like the name suggest, the dynamic knowledge graph of the present disclosure is dynamic and is personalized for each user. This is unlike other knowledge graphs that are static and that share information across many users.

More specifically, the present disclosure is directed to a dynamically-constructed knowledge graph that represents the state of a conversation between the personal digital agent and the user at any point in time. The dynamic knowledge graph includes various data entities of different types such as will be described below.

In the embodiments described, static knowledge graphs (either first party knowledge graphs or third party knowledge graphs) may also be accessible by the dynamic knowledge graph through various application programming interfaces. Each application programming interface that is known and available to the personal digital agent is modeled as an “action” or “action entities” in the dynamic knowledge graph. In some embodiments, the actions are represented as nodes in the dynamic knowledge graph.

A conversation between the personal digital agent and a new user (or a conversation with an existing user whose previous conversation state has been purged by the system) starts out with a dynamic knowledge graph that contains basic default actions (e.g., application programming interfaces) that are available to the personal digital agent system. The actions may include: application programming interfaces to access first party or third party static knowledge graphs; application programming interfaces to build data entities from user input; and application programming interfaces that procedurally generate data entities from an arbitrarily large range (e.g., future dates and times) of possible data entities.

Additional actions available to the personal digital agent system may include actions that are built into the personal digital agent system itself that manipulate the dynamic knowledge graph by modifying or dropping existing data entities in the dynamic knowledge graph. For example, confidence scores associated with different actions and data entities may be modified based on conversation turns with a user. In other examples, actions and/or data entities may be removed from the dynamic knowledge graph based on received information from the user.

The dynamic knowledge graph also, in general includes information about all types of data entities that the various actions accept as input. Additionally, the dynamic knowledge graph tracks the types of data entities that the available actions provide as output. Each time an action provides a data entity as an output, this newly created data entity may be automatically stored in the dynamic knowledge graph.

In some implementations, each data entity and each action in the dynamic knowledge graph may be represented as a node. Each node includes metadata or other information that indicates how the information is likely to be used in the future. This metadata may include a confidence score (such as described above) that indicates how certain the personal digital agent system is that a particular entity represents something the user has discussed. The metadata may also include a state flag that indicates an intended use of the data entity and/or an action. Some of these state flags include a “prompted” flag that indicates that the personal digital agent system has prompted the user to provide additional information related to the data entity and/or an action, a “resolved” flag that indicates that a data entity was recently produced by an existing action, and an “age” flag that indicates the age of the data entity and/or an action (e.g., how many turns earlier in the conversation the entity was added to the dynamic knowledge graph or accessed. Although specific examples are given, additional flags may be used.

These and other embodiments will be discussed in more detail with respect to the figures below.

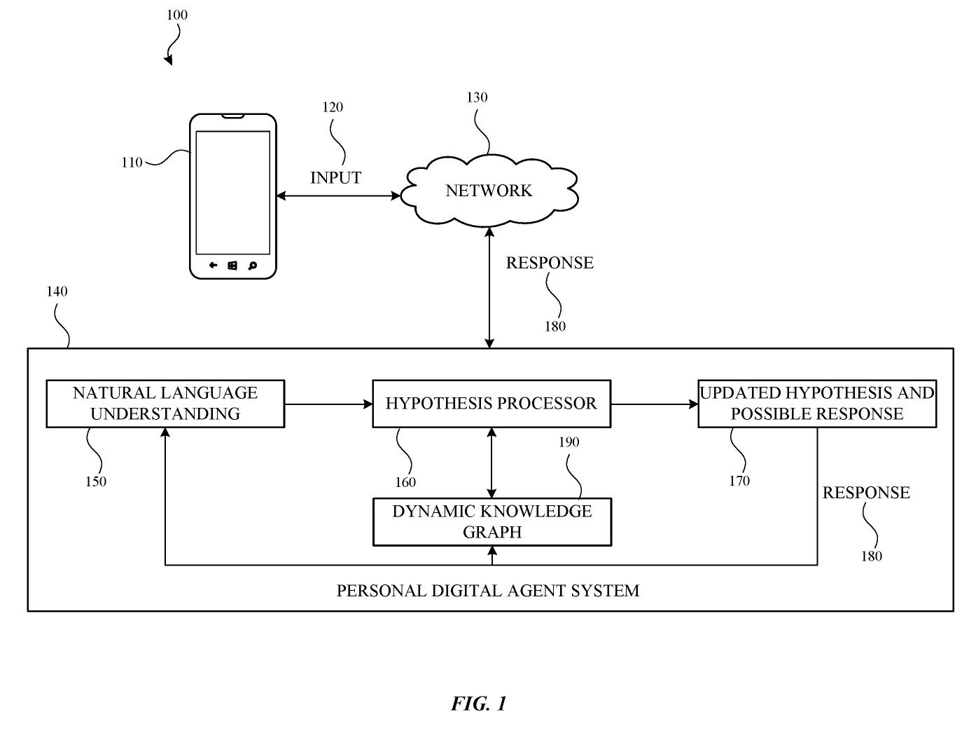

FIG. 1 illustrates an example system 100 that incorporates or is otherwise associated with a dynamic knowledge graph 190 according to an example embodiment. More specifically, the system 100 includes a personal digital agent system 140 that receives input 120 from a user, parses the input 120 to determine an intent of the user and determines whether knowledge contained in the dynamic knowledge graph 190 is sufficient to satisfy the input 120 that was received.

As shown in FIG. 1, the system 100 may include a computing device 110. A user may use the computing device 110 to access the personal digital agent system 140 through a network 130. Example computing devices include, but are not limited to, a mobile telephone, a smart phone, a tablet, a phablet, a smart watch, a wearable computer, a personal computer, a desktop computer, a laptop computer, a gaming device/computer (e.g., Xbox®), a television, or any other device that may use or be adapted to use a personal digital agent. In some instances, a personal digital agent may be present in an automobile, a boat, an airplane, home appliances and the like. Accordingly, the embodiments disclosed herein may also be utilized in such situations.

In some implementations, a personal digital agent may be provided on the computing device 110. As described above, the user may interact with the personal digital agent and provide different forms or types of input. The input 120 may include, but is not limited to text input, voice input, touch input, force input, sound input, image input, video input and combinations thereof.

The input 120 may include a request for the personal digital agent system 140 to perform one or more actions. The actions may include a transactional action (e.g., sending an email, making a telephone call, ordering items/merchandise for the user), providing information in response to a request from the user (e.g., answering questions, performing searches and so on), providing entertainment to the user by conducting a conversation with the user, and so on. The one or more actions may be executed on one or more entities such as will be described below.

Once the input 120 is received, the input 120 is transmitted, through the network 130 to the personal digital agent system 140. As shown, the personal digital agent system 140 may include a natural language understanding component 150, a hypothesis processor 160, an updated hypothesis and possible response component 170 and a dynamic knowledge graph 190.

In some embodiments, the personal digital agent system 140, and its components, may be included on or otherwise be associated with one or more servers. In other embodiments, some of the components of the personal digital agent system 140 may be associated with or hosted by different servers. For example, the personal digital agent system 140, the natural language understanding component 150, the hypothesis processor 160 and the updated hypothesis and possible response component 170 may be hosted by one server while the dynamic knowledge graph 190 may be hosted by a different server.

In yet other embodiments, some of the components that are shown as being part of the personal digital agent system 140 may be included with or otherwise hosted by the computing device 110. Additionally, the computing device 110 may store actions and/or data entities that may be required to execute one or more requests of the user. In some instances, the information may be sensitive or personal information (e.g., social security number, credit card information, and so on) that the user does not want to store on a server. This information may be sent to the dynamic knowledge graph 190 as needed. The dynamic knowledge graph 190 may be configured to add the received actions and/or information in order to execute the request and then may be further configured to remove the sensitive information once the action is complete.

As previously described, the input 120 is received by the personal digital agent system 140 through the network 130. The input 120 is then provided to the natural language understanding component 150. In some instances, the natural language understanding component 150 processes the input 120 and converts it (if necessary) into text. For example, if the input 120 is speech input, the natural language understanding component 150 coverts the speech to text. Likewise, if the input 120 is touch input, the meaning of the touch input may be determined by the natural language understanding component 150 and converted to text. In other implementations, non-text input (e.g., speech or touch input) could be directly annotated with a domain, intent, and extracted entities without having to convert the entire input into raw text.

Once the input is converted to text, the natural language understanding component 150 determines the intent of the input 120. As discussed above, the input 120 may include one or more action requests and/or one or more data entities. Therefore, the intent of the input may be to execute a particular action.

As part of this process, the natural language understanding component 150 tags the input 120 with various information. This information includes a domain, an intent and one or more slots. As used herein, the term “intent” signifies a goal of the user. For example, the intent is a determination as to what a user wants from a particular input. The intent may also instruct the personal digital agent system 140 how to act. A “slot” represents actionable content and exists within the input 120. For example, if the input is “Order me a pizza,” the user's intent is to order a pizza and the slots would include the word pizza.

Once the intent, domain and slots are identified and tagged, one or more hypotheses are generated by the natural language understanding component 150 and sent to the hypothesis processor 160. In one implementation, at least one hypothesis must be created, but multiple hypotheses may be produced. Each hypothesis that is generated corresponds to possible interpretations of the input 120. That is, each hypothesis may correspond to a determined intent of the user.

Once the hypotheses are received by the hypothesis processor 160, it interacts with the dynamic knowledge graph 190 to determine which actions and/or entities in the dynamic knowledge graph 190 may be used to fulfil or otherwise execute the action request contained in the input 120. Continuing with the example above, if the input 120 is “Order me a pizza” the hypothesis processor queries the dynamic knowledge graph 190 to determine which actions and entities in the dynamic knowledge graph 190 can be used to execute the action request of ordering a pizza.

In some embodiments, the hypothesis processor 160 may be configured to take into account the data entities and/or actions that are already present in the dynamic knowledge graph 190 with their associated metadata. For example, multiple action entities may be tagged with various levels of confidence.

The dynamic knowledge graph 190 is configured to track information from the user over time. This information may include long-term preferences of the user, information about the user, which actions can be performed on behalf of the user and so on. As information is added to the dynamic knowledge graph 190, the dynamic knowledge graph may discover or add additional actions that may be performed on behalf of the user. In some instances, the additional actions may be discovered using third party and/or first party application programming interfaces the dynamic knowledge graph 190 has access to.

In some instances the input 120 may include a single action request. In other implementations, the input 120 may include multiple action requests. In each case, each action request may be associated with multiple sub-actions and entities. Each sub-action may need to be executed in order for the action request to be executed.

Continuing with the pizza example above in which the determined action is an order pizza action, the dynamic knowledge graph 190 would need to know, and be able to execute various other sub-actions on entities that would assist in ordering the pizza. These sub-actions that may be executed on data entities may include data such as, whether the user wants to dine-in, order carryout or have the pizza delivered. Other information may include which toppings the user wants, the size of the pizza, which pizza parlor the user wants to order from and so on.

In some instances, all of this information may be stored in the dynamic knowledge graph 190. For example, if the user has ordered pizza within the past couple of weeks, and the input 120 of “Order me a pizza” is received, the hypothesis processor 160 interacts with the dynamic knowledge graph 190 to determine that the user typically orders a large pepperoni pizza from Bob's Pizza for carryout. Accordingly, the dynamic knowledge graph 190 can execute all of the sub-actions on data entities corresponding to size, toppings, pizza parlor and dining preference. As such, it may be determined that the action request can be fully executed with the knowledge contained in the dynamic knowledge graph 190.

In some instances, each sub-action and data entity in the dynamic knowledge graph may be associated with a confidence score. The confidence score may indicate how certain the personal digital agent system 140 is that the correct sub-actions and data entities are being selected. For example, if the user ordered a pepperoni pizza from Bob's pizza in the last week, the confidence score of the sub-actions and entities associated with size, toppings, pizza parlor etc., may be relatively high. Accordingly, the output that is provided in response to the input 120 may be “I will place a carryout order for a large pepperoni pizza for you at Bob's Pizza.” The user may then confirm the output or change the order.

If the output is confirmed, the confidence score of one or more of the sub-actions and/or data entities may increase. If the user changes the order, the confidence score of each of the sub-actions and data entities may decrease.

However, in some instances, the dynamic knowledge graph 190 may not contain all of the knowledge (e.g., sub-actions and/or entities) that are required to complete the action request contained in the input 120. For example, if the user has not used the personal digital agent system 140 to order a pizza, the dynamic knowledge graph 190 may not have sub-actions and/or entities associated with size, toppings, pizza parlor and dining preference. Accordingly, this information may need to be requested. In some instance, the information is requested by examining information stored in independent static knowledge graphs that define typical scenarios. Once this information is received, the information may be added to the dynamic knowledge graph.

Further, the dynamic knowledge graph 190 may not know all of the toppings that are available from Bob's Pizza. In such instances, the dynamic knowledge graph 190 may, through an application programming interface associated with Bob's Pizza, access a static (or dynamic) knowledge graph, a database or other knowledge source that includes information about the various toppings available from Bob's Pizza. This information may then be incorporated or otherwise stored in the dynamic knowledge graph 190. Thus, the dynamic knowledge graph may be continually updated based on various interactions with the user.

Referring back to FIG. 1, as the hypothesis processor 160 interacts with the dynamic knowledge graph 190, the original hypotheses are updated. The updated hypothesis and the responses are generated based on the knowledge contained within the dynamic knowledge graph 190.

For example, if the original hypothesis was an order pizza action, the hypothesis may be updated to indicate (based on actions and entities stored in the dynamic knowledge graph 190) that the personal digital agent system 140 believes that the user wants to place a carryout order for a large pepperoni pizza from Bob's Pizza. One or more possible responses to the input 120 are also generated. Continuing with the example above, one of the possible responses is “I will place a carryout order for a large pepperoni pizza for you at Bob's Pizza.” However, if the dynamic knowledge graph 190 does not include all of the actions and entities to complete the action request, a generated response may be “What kind of pizza would you like to order?” When the user responds, the new information contained in the response is automatically added to the dynamic knowledge graph 190. This information may be used the next time the determined hypothesis is “order pizza.”

The updated hypothesis and the possible responses are then ranked by the updated hypothesis and possible response component 170. The response 180 with the highest rank is selected and provided to the user. In some embodiments, the response 180 may also be provided to the dynamic knowledge graph 190 in order to update the dynamic knowledge graph 190 with that particular turn. In some instances, the response 180 will be a confirmation that the requested action provided in the input 120 has been executed. In other implementations, the response 180 may indicate that additional input from the user is required. This process may continue as needed to execute the action requests contained in the input 120 from a user and to respond to newly received input.

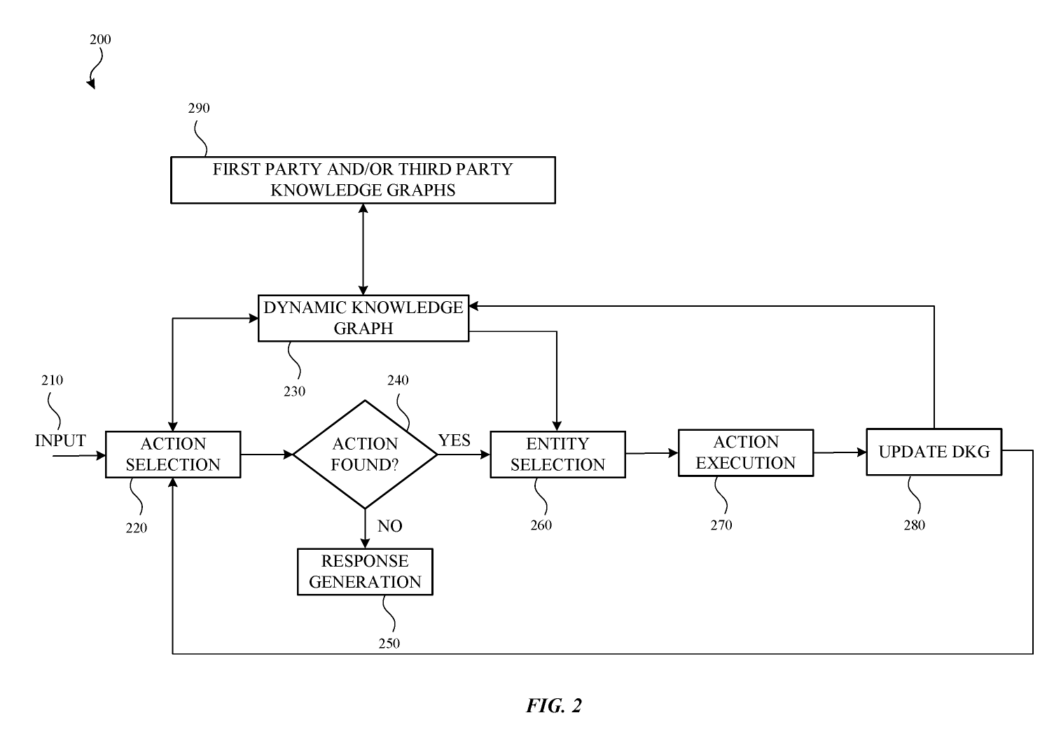

FIG. 2 illustrates additional components that may be included in a personal digital agent system 200. In some embodiments, the personal digital agent system 200 may be equivalent to the personal digital agent system 140 described above with respect to FIG. 1. More specifically, FIG. 2 illustrates various components that may be included as part of a hypothesis processor that is part of the personal digital agent system 200.

In certain embodiments, the personal digital agent system 200 receives input 210. The input 200 may take many forms including text input, voice input, touch input and so on. In the example shown in FIG. 2, the input 210 may be received from a natural language understanding component such as, for example, the natural language understanding component 150 of FIG. 1. As such, the input 210 may include one or more hypotheses. The hypotheses identify one or more actions that the system 200 should take on behalf of the user.

As shown in FIG. 2, the input 210 is received by an action selection component 220. The action selection component 220 examines the hypotheses and/or any actions that were identified by the natural language understanding component and compares the identified actions in the input 210 with the various actions that are stored in the dynamic knowledge graph 230.

In some instances, a determined intent of the input 210, and thus an action in the dynamic knowledge graph 230, may be implicit given a previous turn in the conversation with the user. For example, if it is already established in an initial turn of the conversation that the user's intent is to order a pizza, the user may not need to explicitly state this intent again in later turns. Additionally, any actions and/or entities associated with an order pizza intent may be identified by the dynamic knowledge graph as being the focus of the conversation. In some embodiments, a determination that an intent of the user was expressed in earlier turns of a conversation may be made by the natural language understanding component or by the action selection component 220 as it compares available searches and/or compares available actions in the dynamic knowledge graph 230.

In some embodiments, the input 210 may indicate that the user wants to return to a previously selected action in a particular turn of a conversation, even when the focus of the conversation has changed. In instances such as this, the natural language understanding component may indicate the change in focus. In other instances, the decision to return to the previous focus of the conversation may be made by the action selection component 220 as it compares the determined actions in the input 210 to the actions stored in the dynamic knowledge graph 230.

The action selection component 220 is configured to compare one or more actions in the received input 210 with various actions stored in the dynamic knowledge graph 230. If an action is not found in the dynamic knowledge graph 230, a matching component 240 indicates that a matching action was not found. As a result, a response generation component 250 generates a response that is provided to the user to indicate that additional input is required to execute the action that was contained in the input 210.

Continuing with the example above, if the input 210 was a request to order a pizza and the dynamic knowledge graph 230 does not have any information about the kind of pizza the user wants, the response generation component 250 would prepare one or more responses that may be used to identify the kind of pizza the user wants to order.

If the action selection component 220 finds a matching action in the dynamic knowledge graph 230 that should be executed as part of processing the input 210, the system 200 attempts to match the existing action in the dynamic knowledge with various data entities that are also stored in the dynamic knowledge graph 230. Stated differently, once an action in the dynamic knowledge graph 230 is identified, the action needs to be executed on a data entity that is stored in the dynamic knowledge graph 230. The entity selection component 260 selects which data entity in the dynamic knowledge graph 230 will be used as input to the identified action. In some embodiments, the selection of the data entity is based on metadata (e.g., confidence score, flag, etc.) associated with the data entity.

As discussed above, if a determination is made by the matching component 240 that the dynamic knowledge graph 230 contains insufficient information to execute the action contained in the input 210, a search or traversal process may be used in which inputs to the actions are mapped with outputs of other available actions in the dynamic knowledge graph 230. The search may continue until the system 200 determines that a set of entities (e.g., an action and an associated input data entity) that can be acted upon by the system exist in the dynamic knowledge graph 230 or it is determined that additional input from the user is required.

If a suitable action is found in the dynamic knowledge graph 230, the action execution component 270 executes the determined action on the associated data entity. The output from the action execution component 270 is then used by the update dynamic knowledge graph component 280 to update the dynamic knowledge graph 230.

In some implementations, the search (or traversal) process repeats with the newly updated dynamic knowledge graph 230. This process may continue until either all the actions (e.g., sub-actions associated with the action request contained in the input 210) corresponding to the user's initial input are executed or the dynamic knowledge graph 230 doesn't include actions that can be executed that would enable to the initial action request contained in the input 210 to be executed.

In some instances, the dynamic knowledge graph 230 may not contain all the information required to execute the action request contained in the input 210. In such cases, the system 200 may be configured to obtain additional information from other knowledge graphs. These knowledge graphs may be hosted by a separate server or may be hosted by the same server on which the system 200 is hosted. For example, and as shown in FIG. 2, the dynamic knowledge graph 230 may communicate with and query a first party and/or third party knowledge graphs 290 for actions and/or data entities that are associated with the action contained in the input 210. The actions and the corresponding data entities in the first party and/or third party knowledge graphs 290 may then be provided to the knowledge graph 230 and/or action selection component 220 (via an application programming interface). The system 200 may then update the dynamic knowledge graph 230 with the newly discovered actions and data entities.

In some aspects, certain actions in the dynamic knowledge graph can be used to modify the dynamic knowledge graph 230 itself. For example, an executed action may be used to modify a confidence score or a flag of various data entities in the system 200. In other implementations, actions contained in the dynamic knowledge graph may be used to remove the data entities and/or actions from the dynamic knowledge graph 230 entirely.

For example, if the input 210 includes an order pizza action, it may be determined, using knowledge contained in the dynamic knowledge graph 230, that the user typically orders Hawaiian pizza. Therefore, as a result of the input 210, the system 200 may provide a response of “I see that you typically order Hawaiian pizza. Is that the kind you want to order?” They user may respond with “No, I never want to order that again. The pineapple made me sick.” In this case, the system 200 is highly confident, based on the user's input, that the data entity associated with pineapple (or another data entity that the system 200 has prompted the user about) may be removed from or otherwise marked as strongly disliked, not as relevant etc. in the dynamic knowledge graph 230. The action to remove (or marked as disliked, not as relevant, etc.) the data entity associated with pineapple may be stored within the dynamic knowledge graph 230.

In other aspects, metadata associated with each action or other data entities in the dynamic knowledge graph 230 may be updated. This metadata may include the confidence level associated with the data entities and action and/or any state flags that are associated with the data entities and actions. For example, executing a particular action in response to an input 210 would increase the confidence of the system 200 that a particular action and its associated data entities, which served as input to the action, are relevant to a particular conversation. Thus the dynamic knowledge graph can be used to track the focus and the state of entities in a conversation.

Although the examples above give instances in which single hypotheses are present based on received input 210, the system 200 may be used to process multiple hypotheses in parallel. Further, the dynamic knowledge graph 230 may be configured to receive multiple updates in parallel, some of which increase certain confidence scores and others with decrease the confidence scores.

Returning back to FIG. 2, when an action is executed (e.g., a sub-action that is identified as being associated with the action identified in the input 210), one or more output entities may be created. These output entities are added to the dynamic knowledge graph 230. In some instances, the output entities may be data entities or additional actions. In some cases, the entities may not have been previously known by the dynamic knowledge graph 230. Thus, by executing certain actions, the dynamic knowledge graph 230 can automatically expand to include additional actions.

As previously discussed, once it is determined that no more actions may be executed for the given input 210 (either because the action request contained in the input 210 has been fully executed or because the dynamic knowledge graph 230 does not contain any actions (e.g., sub-actions) and/or data entities leading to the action request can be executed) the matching component 240 in association with the response generation component 250 constructs an appropriate response to provide to the user.

In some embodiments, the generated response may: inform the user of a decision made by the system 200, such as which actions have been selected and/or which data entities have been produced as a result of executing certain actions; inform the user of the result of executing the action contained in the input 210; inform the user that one or more actions cannot be completed using the available information in the dynamic knowledge graph 230; request the user provide additional information before a certain actions can be executed; and inform the user of errors which may have occurred during the execution of an action. Although specific examples have been given, other responses may be generated and provided by the response generation component 250.

The system 200 is responsible for selecting an appropriate response given the set of actions that were executed during a given turn in the conversation with the user. In some cases, the final response that is generated by the response generation component 250 may aggregate multiple types of information. For example, the system 200 may select or generate a single dialog action that indicates the system's 200 understanding of the intent of the user (and thus the action request identified in the input 210). In another example, the system may select or generate two dialog actions that indicate that two intermediate actions (or sub-actions) have been executed and a dialog action requesting that the user provide additional input so the action request can be fully executed.

In some instances and as described above, the system 200 may generate a single hypothesis or multiple hypotheses. Depending on the number of hypotheses, the system may prepare a response for each. In some implementations, the system 200, may be configured to rank each hypothesis. In some implementations, each hypothesis may be ranked in terms of relevance and/or a confidence score In some cases, the ranking may be done by updated hypothesis and possible response component 170 (FIG. 1). The updated hypothesis and possible response component may be integrated with the response generation component 250. Once the hypotheses and/or responses are ranked, a single output is selected and provided by the system 200. In some instances, even if certain hypotheses and outputs are not selected for presentation to a user, these hypotheses and output may still be used to update the dynamic knowledge graph 230.

In some cases, the communication of the generated responses may be multimodal. That is, the responses may include auditory (spoken text or other sounds), visual (written text and/or rich UI elements), and tactile (e.g., haptic feedback) components. The system 200 then waits for further interaction from the user such as, for example, the user providing a new turn in the conversation.

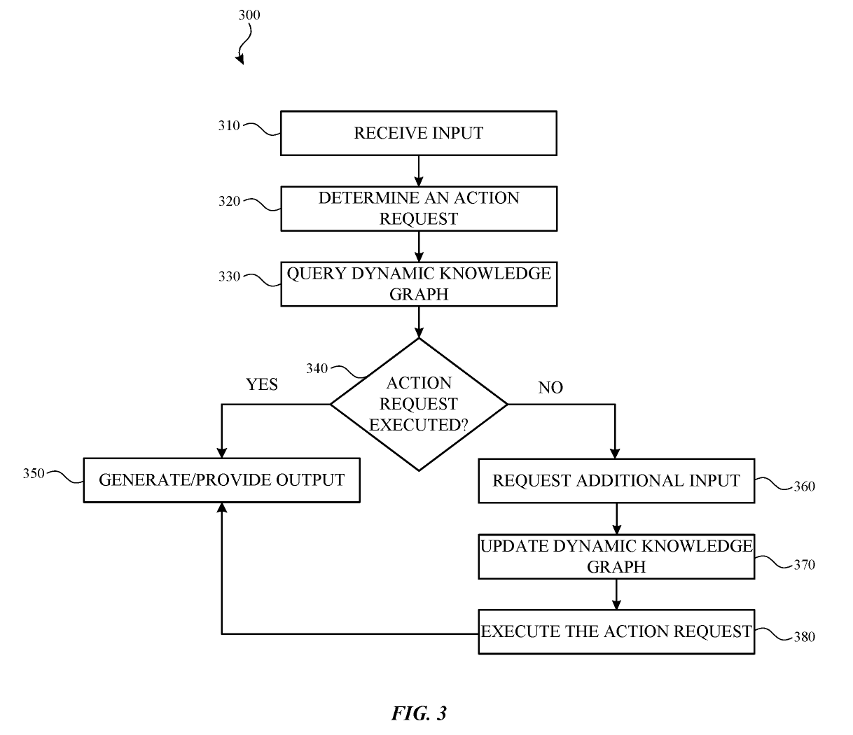

FIG. 3 illustrates a method 300 for updating a dynamic knowledge graph associated with a personal digital agent system according to one or more embodiments of the present disclosure. The method 300 may be used by the system 100 and/or the system 200 described above with respect to FIG. 1 and FIG. 2.

Method 300 begins at operation 310 in which input from a user is received by a personal digital agent. In some embodiments, the personal digital agent may be provided on a computing device. In other examples, the personal digital agent may be associated with an automobile (e.g., a navigation and/or entertainment system in the automobile), an airplane, a home appliance, a home security system and so on. The personal digital agent may be configured to perform one or more tasks or target actions for the user based on the received input. The input may be text input, speech input, tactile input, video input, sound input and so on.

Once the input is received, flow proceeds to operation 320 in which the input is processed to determine an action request contained in the input. In some aspects, the input may be processed by a natural language understanding component, such as, for example, natural language understanding component 150 of FIG. 1. The natural language understanding component may be configured to generate one or more hypotheses that include a determination as to what the user wants to accomplish with the received input. In some cases the natural language understanding component may tag the input with a domain, an intent and one or more slots such as described above. This may occur for a single input or for multiple turns in a conversation.

Flow then proceeds to operation 330 and a dynamic knowledge graph associated with the personal digital agent system is queried to determine whether the dynamic knowledge graph includes one or more actions and/or data entities that may be used to execute the action request contained in the input. In some instances, the dynamic knowledge graph is personalized with respect to the user. For example, each user of the personal digital agent system may have their own dynamic knowledge graph.

The dynamic knowledge graph may be queried in any number of ways. For example, the dynamic knowledge graph may be indexed to determine which actions and entities it contains. In another example, the actions and entities contained in the dynamic knowledge graph may be provided on a list. The action request may then be compared to the list. In other implementations, the dynamic knowledge graph may be represented as a list of Resource Description Framework (RDF) tuples. Although specific examples are given, the dynamic knowledge graph may be queried in any number of different ways.

In operation 340, a determination is made as to whether the dynamic knowledge graph includes actions (or sub-actions) and/or entities that may be used to fully execute the target action contained in the input. As described above, a single action request may require that multiple sub-actions be performed on various entities. If it is determined (e.g., by an action selection component) that the dynamic knowledge graph includes all required actions and entities to fully execute the target action, flow proceeds to operation 350 and a response is generated and provided to the user.

In some cases, multiple hypotheses may be generated in operation 320. As such, multiple outputs may also be generated. However, the hypotheses and the responses are may be ranked. In such cases, the highest rank response may be provided to the user such as previously described.

If it is determined in operation 340 that the action request cannot be fully executed (e.g., the dynamic knowledge graph does not contain actions and/or entities that enable the action request to be fully executed) flow proceeds to operation 360 and the system requests additional input from the user. In some cases, the request for input may include an indication of which sub-actions have been performed on the user's behalf and what information is still needed.

Flow then proceeds to operation 370 and the dynamic knowledge graph is updated with the received input. The action request may then be executed using the newly received input in operation 380. Once the action request has been executed, flow proceeds to operation 350 and a response is generated such as described above. As also shown in FIG. 3, flow may also proceed back to operation 320 which enables further processing of the input in the same (or a subsequent) conversation turn. The process described, or portions thereof, may be executed additional times based on the number of turns in a conversation.

The following illustrates a few examples of a pizza ordering interaction and how a dynamic knowledge graph may be updated. The example is intended to illustrate how the various components of the systems described above react to various types of input that is provided.

In the first example, the personal digital agent may be requested to perform a single task—a simple pizza order task. In this example, the user may be limited to ordering a single pizza that is preselected so the user cannot customize it or change it. In this example, a dynamic knowledge graph contains two nodes (or actions) that can serve as the target action: an “OrderPizza” action which returns an “OrderIdType” entity when invoked and an “Other” action which returns a default “BooleanType” value (with a value of true) when invoked.

In this example, the dynamic knowledge graph also contains a number of other action nodes which produce intermediate entities required by the OrderPizza action. These actions include: a “ResolveLocation” action which returns fully-qualified addresses of type “LocationType;” a “ResolveOrderType” action which returns an “OrderType” (e.g. Carryout or Delivery) entity; a “ResolvePizzaType” action which returns a “PizzaType” (e.g. Hawaiian, MeatLovers, Vegetarian and so on) entity; and a “ResolvePizzaSize” action which returns a “PizzaSizeType” (e.g., small, medium, or large) entity.

The dynamic knowledge graph may also contain a number of dynamic knowledge graph management action nodes that assist in the maintenance and updating of the dynamic knowledge graph. These actions may include: an “IgnoreEntity” action; a “SelectEntity” Action; and a “Cancel” action.

The dynamic knowledge graph also contains information about different types of data entities supported by all the actions contained in the dynamic knowledge graph, including OrderIdType, LocationType, OrderType, PizzaType, PizzaSizeType, and BooleanType. In this example, no other entities exist in the dynamic knowledge graph prior to the start of the conversation.

When the user initiates a conversation with the personal digital agent and provides an input (e.g., an input of ordering a pizza), at each turn in the conversation, the system would produce only one hypothesis. The user's intent would be mapped to either the OrderPizza action or the Other action. If the Other action is tagged, no further input is required from the user and the system would select a response informing the user that their intended action is not supported by this personal digital agent.

However, if the OrderPizza Action is tagged, then the system would attempt to search for a sequence of actions in the dynamic knowledge graph which, when executed, would allow the personal digital agent to eventually execute the OrderPizza action. In this example, a sequence of actions that need to be resolved for the initial turn in the conversation might be the ResolveLocation action, the ResolveOrderType action, the ResolvePizzaType action, the ResolvePizzaSize action, and the OrderPizza action. For each action in the sequence, if all the required inputs or data entities are present (e.g., address, carryout, Hawaiian etc.), the OrderPizza action (which is associated with the original intent of the conversation) would be executed.

If one or more of the entities or inputs is not present in the dynamic knowledge graph, the system would stop executing the actions and generate a response indicating what information the user is required to provide in order for the system to execute a particular action. Since the only hypothesis is a pizza order hypothesis, the hypothesis ranking step would not be needed as the single hypothesis would be displayed to the user. The conversation would continue in which additional data is requested from the user until the OrderPizza action could be executed. In some instances, the personal digital agent may determine that user changed their intended action to Other. In such cases, the conversation would terminate.

In the following example, the personal digital agent system allows for customization of orders and the ordering of multiple pizzas. Further, the personal digital agent system remembers past orders so that users may easily re-order their favorites. Once an order is placed, the user may attempt to modify or cancel it. In this case, many more actions may be required to determine the intent of the user and ensure that the action request in the input is fully executed. In this example, since additional user intents are available, additional action nodes (action nodes in addition to the action nodes described in the previous example) may be added to the dynamic knowledge graph. These include: a “RetrievePreviousOrder” action; a “ReviewExistingOrder” action; a “ModifyExistingOrder” action; and a “CancelExistingOrder” action.

Similarly, more intermediate actions may be required to handle the various new pieces of information that a user may provide. These include toppings, specifying types of drinks, specifying the size of drinks, and retrieving previous orders. For clarity, these actions and their associated entities are not listed. However, the system would need to support a “CustomPizzaType” and at least one new action would be required to allow the user to create new entities of type CustomPizzaType dynamically from other entities previously specified. For example, the system may need to add an action that creates a new custom pizza given user-specified pizza size, crust, sauce, cheese, and other toppings.

The dynamic knowledge graph modifying actions listed above may be used to operate on the various entities described above. However, selecting the correct entities might be more difficult. For example, since both pizzas and drinks may have a SizeType attribute or entity, a user utterance such as “make them all large” may be ambiguous if the user had not previously (or recently during the conversation) discussed size with respect to pizza or drinks. On the other hand, if the user had just modified the size of one particular pizza, the system would be able to deduce that the user's likely intent was to modify all of the other pizza sizes and not the drinks.

As also previously discussed, the personal digital agent system can shift the focus of a conversation. The following are examples of how focus shifting can be accomplished.

In this example, a list of entities of type PizzaType have been added to the dynamic knowledge graph as a result of an earlier action execution. For example, the system provided a list of pizzas matching the user's criteria. In this example, all of the pizzas have a similar confidence score. In a subsequent turn of the conversation, the user may ask “What's the cheapest?” The user's request would be matched to an existing Action in the dynamic knowledge graph, such as “ArgMin(List<PizzaType>, FieldElementType).”

The first argument would be selected as the list of items and the criterion “cheapest” would be resolved to an entity of type FieldElementType with value “Price.” The action would adjust the metadata of each element of the list so that the cheapest element would be given higher confidence and the confidence of the remaining elements (e.g., those that are more expensive) would be reduced. This shifts the focus over the dynamic knowledge graph to the entity selected by the “ArgMin” action.

In a second example, the list of PizzaType entities is provided to the user. However, the focus has shifted such that the confidence of the system is highest in the element selected by the ArgMin action such as described above. In this example, during the conversation the user states “No, I meant the six cheese pizza.” In response to this request, a built-in Selection(List<GenericType>) action would trigger again on the same list. The confidence of the entities in the list would be recomputed so that the entity that best matched the user information (in this case, “six cheese”) would be given higher confidence.

The personal digital agent system can also “forget” previously provided information. In this example, the list of PizzaType entities included a Hawaiian pizza as the output of the ArgMin Action (e.g., the Hawaiian pizza had been selected as the cheapest pizza in the list and thus its confidence in the dynamic knowledge graph had been adjusted) and provided to the user. In response, the user may provide input of “I don't like Hawaiian pizza anymore.”

In response to the new input, a built-in ClearEntity(GenericType) action contained in the dynamic knowledge graph would be executed. The input to the ClearEntity action would be an element having a matching string (e.g., “Hawaiian”). The output provided by the ClearEntity(GenericType) action would be to reduce the confidence level of input entity “Hawaiian.” For example, the confidence score could be reduced to either to 0 or to a very low value to indicate that it is no longer in focus of the conversation.

In some embodiments, the dynamic knowledge graph does not need to know anything about all of the actions it is associated with. For example, the dynamic knowledge graph may not know anything about the type OrderIdType or the actions related to order management actions listed above. In such cases, the OrderPizza action could return, in addition to the OrderId entity, the type entity OrderIdType, together with the new actions RetrievePreviousOrder, ReviewExistingOrder, ModifyExistingOrder, and CancelExistingOrder.

Although specific and simplified examples are given, the personal digital agent system and the associated dynamic knowledge graph may be scaled to handle hundreds of tasks. However, as the complexity of the system increases, ranking the various actions becomes more important as the various actions may compete against one another. Accordingly, the system may support early filtering and late-stage ranking. Early filtering may be used to restrict processing to only a small subset of the possible actions. Late stage ranking may be used to select the single best response and provide it to the user.

In yet other implementations, certain actions may have transaction side-effects. In one example, an action may have involve a monetary exchange. In such cases, the execution of a transaction action such as this and any action that could be executed after the transaction is complete, would be delayed for a predetermined amount of time until the final ranking of actions and output has occurred. In some embodiments, a post-ranking and a second-pass execution stage could be invoked and the final response shown to the user would be computed only once all post-ranking actions are executed.

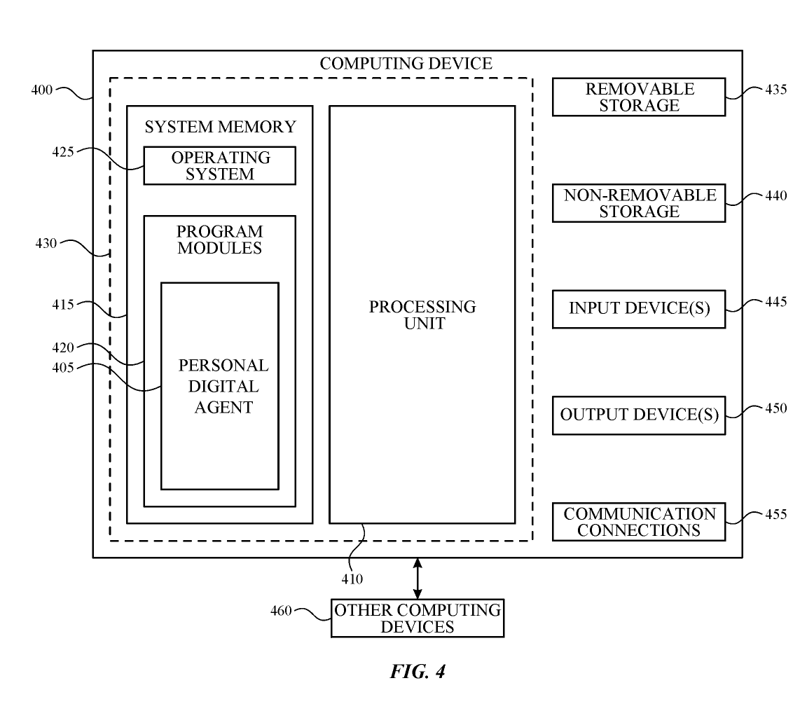

FIGS. 4-7 and the associated descriptions provide a discussion of a variety of operating environments in which aspects of the disclosure may be practiced. However, the devices and systems illustrated and discussed with respect to FIGS. 4-7 are for purposes of example and illustration and are not limiting of a vast number of electronic device configurations that may be utilized for practicing aspects of the disclosure, as described herein.

FIG. 4 is a block diagram illustrating physical components (e.g., hardware) of an electronic device 400 with which aspects of the disclosure may be practiced. The components of the electronic device 400 described below may have computer executable instructions for causing a personal digital agent to interact with and update a dynamic knowledge graph such as described above.

In a basic configuration, the electronic device 400 may include at least one processing unit 410 and a system memory 415. Depending on the configuration and type of electronic device, the system memory 415 may comprise, but is not limited to, volatile storage (e.g., random access memory), non-volatile storage (e.g., read-only memory), flash memory, or any combination of such memories. The system memory 415 may include an operating system 425 and one or more program modules 420 suitable for parsing received input, determining subject matter of received input, determining actions associated with the input and so on.

The operating system 425, for example, may be suitable for controlling the operation of the electronic device 400. Furthermore, embodiments of the disclosure may be practiced in conjunction with a graphics library, other operating systems, or any other application program and is not limited to any particular application or system. This basic configuration is illustrated in FIG. 4 by those components within a dashed line 430.

The electronic device 400 may have additional features or functionality. For example, the electronic device 400 may also include additional data storage devices (removable and/or non-removable) such as, for example, magnetic disks, optical disks, or tape. Such additional storage is illustrated in FIG. 4 by a removable storage device 435 and a non-removable storage device 440.

As stated above, a number of program modules and data files may be stored in the system memory 415. While executing on the processing unit 410, the program modules 420 (e.g., the content sharing module 405) may perform processes including, but not limited to, the aspects, as described herein.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the electronic device 400 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The electronic device 400 may also have one or more input device(s) 445 such as a keyboard, a trackpad, a mouse, a pen, a sound or voice input device, a touch, force and/or swipe input device, etc. The output device(s) 450 such as a display, speakers, a printer, etc. may also be included. The aforementioned devices are examples and others may be used. The electronic device 400 may include one or more communication connections 455 allowing communications with other electronic devices 460. Examples of suitable communication connections 455 include, but are not limited to, radio frequency (RF) transmitter, receiver, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules.

The system memory 415, the removable storage device 435, and the non-removable storage device 440 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the electronic device 400. Any such computer storage media may be part of the electronic device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

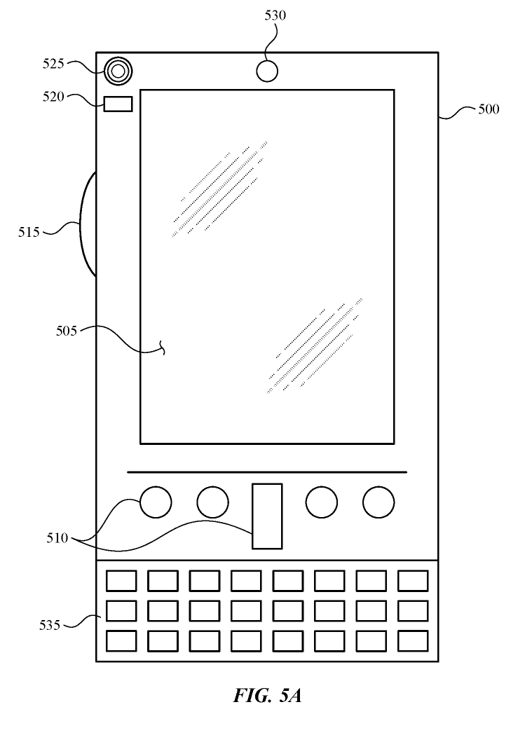

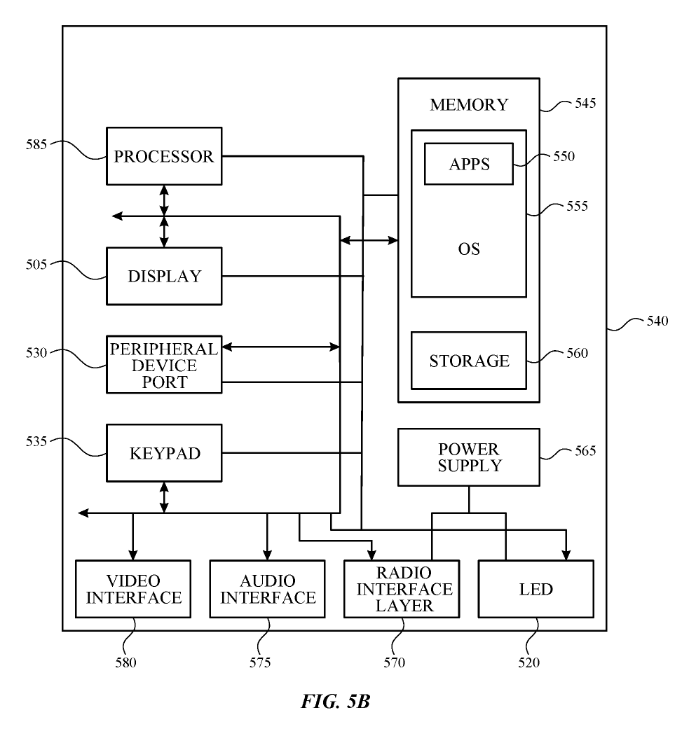

FIGS. 5A and 5B illustrate a mobile electronic device 500, for example, a mobile telephone, a smart phone, wearable computer (such as a smart watch), a tablet computer, a laptop computer, and the like, with which embodiments of the disclosure may be practiced. With reference to FIG. 5A, one aspect of a mobile electronic device 500 for implementing the aspects is illustrated.

In a basic configuration, the mobile electronic device 500 is a handheld computer having both input elements and output elements. The mobile electronic device 500 typically includes a display 505 and one or more input buttons 510 that allow the user to enter information into the mobile electronic device 500. The display 505 of the mobile electronic device 500 may also function as an input device (e.g., a display that accepts touch and/or force input).

If included, an optional side input element 515 allows further user input. The side input element 515 may be a rotary switch, a button, or any other type of manual input element. In alternative aspects, mobile electronic device 500 may incorporate more or less input elements. For example, the display 505 may not be a touch screen in some embodiments. In yet another alternative embodiment, the mobile electronic device 500 is a portable phone system, such as a cellular phone. The mobile electronic device 500 may also include an optional keypad 535. Optional keypad 535 may be a physical keypad or a “soft” keypad generated on the touch screen display.

In various embodiments, the output elements include the display 505 for showing a graphical user interface (GUI), a visual indicator 520 (e.g., a light emitting diode), and/or an audio transducer 525 (e.g., a speaker). In some aspects, the mobile electronic device 500 incorporates a vibration transducer for providing the user with tactile feedback. In yet another aspect, the mobile electronic device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one aspect of a mobile electronic device 500. That is, the mobile electronic device 500 can incorporate a system (e.g., an architecture) 540 to implement some aspects. In one embodiment, the system 540 is implemented as a “smart phone” capable of running one or more applications (e.g., browser, e-mail, calendaring, contact managers, messaging clients, games, media clients/players, content selection and sharing applications and so on). In some aspects, the system 540 is integrated as an electronic device, such as an integrated personal digital assistant (PDA) and wireless phone.

One or more application programs 550 may be loaded into the memory 545 and run on or in association with the operating system 555. Examples of the application programs include phone dialer programs, e-mail programs, personal information management (PIM) programs, word processing programs, spreadsheet programs, Internet browser programs, messaging programs, and so forth.

The system 540 also includes a non-volatile storage area 560 within the memory 545. The non-volatile storage area 560 may be used to store persistent information that should not be lost if the system 540 is powered down.

The application programs 550 may use and store information in the non-volatile storage area 560, such as email or other messages used by an email application, and the like. A synchronization application (not shown) also resides on the system 540 and is programmed to interact with a corresponding synchronization application resident on a host computer to keep the information stored in the non-volatile storage area 560 synchronized with corresponding information stored at the host computer.

The system 540 has a power supply 565, which may be implemented as one or more batteries. The power supply 565 may further include an external power source, such as an AC adapter or a powered docking cradle that supplements or recharges the batteries.

The system 540 may also include a radio interface layer 570 that performs the function of transmitting and receiving radio frequency communications. The radio interface layer 570 facilitates wireless connectivity between the system 540 and the “outside world,” via a communications carrier or service provider. Transmissions to and from the radio interface layer 570 are conducted under control of the operating system 555. In other words, communications received by the radio interface layer 570 may be disseminated to the application programs 550 via the operating system 555, and vice versa.

The visual indicator 520 may be used to provide visual notifications, and/or an audio interface 575 may be used for producing audible notifications via an audio transducer (e.g., audio transducer 525 illustrated in FIG. 5A). In the illustrated embodiment, the visual indicator 520 is a light emitting diode (LED) and the audio transducer 525 may be a speaker. These devices may be directly coupled to the power supply 565 so that when activated, they remain on for a duration dictated by the notification mechanism even though the processor 585 and other components might shut down for conserving battery power. The LED may be programmed to remain on indefinitely until the user takes action to indicate the powered-on status of the device.

The audio interface 575 is used to provide audible signals to and receive audible signals from the user (e.g., voice input such as described above). For example, in addition to being coupled to the audio transducer 525, the audio interface 575 may also be coupled to a microphone to receive audible input, such as to facilitate a telephone conversation. In accordance with embodiments of the present disclosure, the microphone may also serve as an audio sensor to facilitate control of notifications, as will be described below.

The system 540 may further include a video interface 580 that enables an operation of peripheral device 530 (e.g., on-board camera) to record still images, video stream, and the like. The captured images may be provided to the artificial intelligence entity advertisement system such as described above.

A mobile electronic device 500 implementing the system 540 may have additional features or functionality. For example, the mobile electronic device 500 may also include additional data storage devices (removable and/or non-removable) such as, magnetic disks, optical disks, or tape. Such additional storage is illustrated in FIG. 5B by the non-volatile storage area 560.

Data/information generated or captured by the mobile electronic device 500 and stored via the system 540 may be stored locally on the mobile electronic device 500, as described above, or the data may be stored on any number of storage media that may be accessed by the device via the radio interface layer 570 or via a wired connection between the mobile electronic device 500 and a separate electronic device associated with the mobile electronic device 500, for example, a server computer in a distributed computing network, such as the Internet. As should be appreciated such data/information may be accessed via the mobile electronic device 500 via the radio interface layer 570 or via a distributed computing network. Similarly, such data/information may be readily transferred between electronic devices for storage and use according to well-known data/information transfer and storage means, including electronic mail and collaborative data/information sharing systems.

As should be appreciated, FIG. 5A and FIG. 5B are described for purposes of illustrating the present methods and systems and is not intended to limit the disclosure to a particular sequence of steps or a particular combination of hardware or software components.

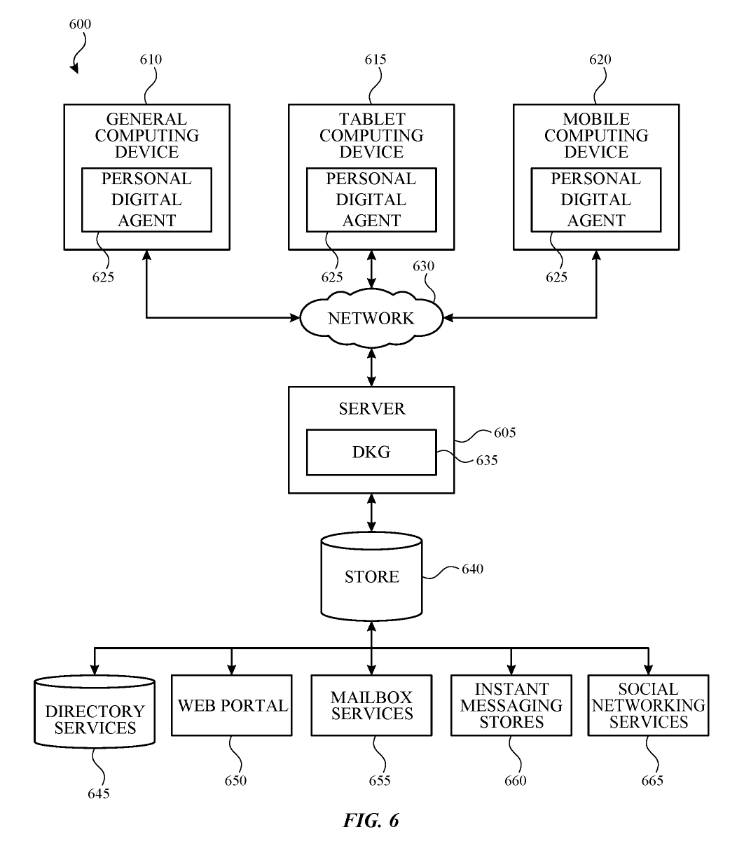

FIG. 6 illustrates one aspect of the architecture of a personal digital agent system 600 such as described herein. The system may include a general electronic device 610 (e.g., personal computer), tablet electronic device 615, or mobile electronic device 620, as described above. Each of these devices may include a personal digital agent 625 for interacting with a user such as described above. Each personal digital agent may also access a network 630 to interact with and update a dynamic knowledge graph 635 stored on a server 605.

In some aspects, the dynamic knowledge graph 635 may receive various types of information or content that is stored by the store 640 or transmitted from a directory service 645, a web portal 650, mailbox services 655, instant messaging stores 660, or social networking services 665.

By way of example, the aspects described above may be embodied in a general electronic device 610 (e.g., personal computer), a tablet electronic device 615 and/or a mobile electronic device 620 (e.g., a smart phone). Any of these embodiments of the electronic devices may obtain content from or provide data to the store 640.

As should be appreciated, FIG. 6 is described for purposes of illustrating the present methods and systems and is not intended to limit the disclosure to a particular sequence of steps or a particular combination of hardware or software components.

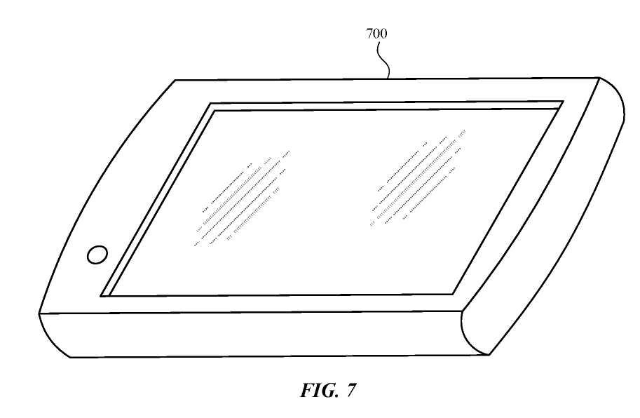

FIG. 7 illustrates an example tablet electronic device 700 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board electronic device displays or via remote display units associated with one or more electronic devices.

For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated electronic device is equipped with detection (e.g., camera) functionality for capturing and interpreting user gestures for controlling the functionality of the electronic device, and the like.

As should be appreciated, FIG. 7 is described for purposes of illustrating the present methods and systems and is not intended to limit the disclosure to a particular sequence of steps or a particular combination of hardware or software components.

Among other examples, aspects of the present disclosure describe a system comprising: a processing unit; and a memory storing computer executable instructions which, when executed by the processing unit, causes the system to perform a method, comprising: receiving input; parsing the input to determine an action request contained in the input; accessing a dynamic knowledge graph to determine whether an action and an entity stored in the dynamic knowledge graph are associated with the action request; when it is determined that the dynamic knowledge graph includes an action and an entity that is associated with the action request: executing the action on the entity; and when it is determined that the dynamic knowledge graph does not include an action and an entity that is associated with the action request: requesting additional input associated with the action request; and automatically updating the dynamic knowledge graph with the additional input. In other aspects, the system further comprises instructions for: determining whether the executed action satisfies the action request; and requesting additional input when it is determined that the executed action does not satisfy the action request. In other aspects, the system further comprises instructions for automatically updating the dynamic knowledge graph with the additional input when the additional input is received. In other aspects, the system further comprises instructions for accessing a third party application programming interface to determine additional information associated with the action request. In other aspects, the system further comprises instructions for adding one or more actions or one or more entities provided by the third party application programming interface into the dynamic knowledge graph. In other aspects, the system further comprises instructions for dynamically updating a confidence score associated with the action when the action is executed on the entity. In other aspects, the system further comprises instructions for dynamically updating a confidence score associated with the action based on the additional input. In other aspects, automatically updating the dynamic knowledge graph with the additional input comprises at least one of adding an additional action and adding an additional entity.

Also described is a method for determining an intent of received input in a personal digital agent system, comprising: receiving an input; determining an action request associated with the input; querying a dynamic knowledge graph to determine whether the action request can be fully executed with the knowledge contained in the dynamic knowledge graph; when it is determined that the action request cannot be fully executed with the knowledge contained in the dynamic knowledge graph: requesting additional input; automatically adding the additional input into the dynamic knowledge graph; and executing the action request using the additional input. In further aspects, the additional input is an action. In further aspects, the additional input is an entity. In further aspects, the method further comprises accessing a knowledge graph to obtain an entity or an action associated with the action request. In further aspects, the method further comprises updating a confidence score of an action associated with the action request when the action request is fully executed. In other aspects, the method further comprises updating a confidence score of an action associated with the action request when the action request cannot be fully executed. In other aspects, the method further comprises executing one or more actions associated with the action request prior to requesting additional input when it is determined that the action request cannot be fully executed. In some aspects, querying a dynamic knowledge graph to determine whether the action request can be fully executed with the knowledge contained in the dynamic knowledge graph comprises indexing one or more actions and one or more entities contained in the knowledge graph.

Also described is a computer-readable storage medium storing computer executable instructions which, when executed by a processing unit, causes the processing unit to perform a method for updating dynamic knowledge graph, comprising: receiving an input; determining an intent of the input; querying the dynamic knowledge graph to determine whether one or more actions within the dynamic knowledge graph can be executed to satisfy the intent of the input; when it is determined that the dynamic knowledge graph does not include one or more actions to satisfy the intent of the input: receiving additional input; and automatically updating the dynamic knowledge graph with the additional input. In some aspects, the additional input is received from a third party application programming interface. In some aspects, the additional input is one of spoken input, text input, or touch input. In some aspects, querying the dynamic knowledge graph comprises indexing the dynamic knowledge graph.

The present disclosure does not limit the scope of possible implementations for each decision point in a dynamic knowledge graph or in the system as a whole. Some implementations may use sets of hand-crafted rules for one or more of the decisions. Other implementations may use separate statistical models for each decision point, including models such as Support Vector Machines (SVM), Conditional Random Fields (CRF), Gradient-Boosted Decision Trees (GBDT) or various flavors of Neural Networks (NN). In other implementations, multiple decisions may be combined in a single model using some of the above methods, such as a single NN with multiple outputs. Mixed statistical and rule-based systems may also be used in some implementations.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
a processing unit; and
a memory storing computer executable instructions which, when executed by the processing unit, causes the system to perform a method, comprising:
receiving input;
parsing the input to determine an action request contained in the input;
accessing a dynamic knowledge graph to determine whether an action and an entity stored in the dynamic knowledge graph are associated with the action request;
when it is determined that the dynamic knowledge graph includes an action and an entity that is associated with the action request:
executing the action on the entity; and
when it is determined that the dynamic knowledge graph does not include an action and an entity that is associated with the action request:
requesting additional input associated with the action request; and
automatically updating the dynamic knowledge graph with the additional input.

2. The system of claim 1, further comprising instructions for:
determining whether the executed action satisfies the action request; and
requesting additional input when it is determined that the executed action does not satisfy the action request.

3. The system of claim 2, further comprising instructions for automatically updating the dynamic knowledge graph with the additional input when the additional input is received.

4. The system of claim 1, further comprising instructions for accessing a third party application programming interface to determine additional information associated with the action request.

5. The system of claim 4, further comprising instructions for adding one or more actions or one or more entities provided by the third party application programming interface into the dynamic knowledge graph.

6. The system of claim 1, further comprising instructions for dynamically updating a confidence score associated with the action when the action is executed on the entity.

7. The system of claim 1, further comprising instructions for dynamically updating a confidence score associated with the action based on the additional input.

8. The system of claim 1, wherein automatically updating the dynamic knowledge graph with the additional input comprises at least one of adding an additional action and adding an additional entity.

9. A method for determining an intent of received input in a personal digital agent system, comprising:
receiving an input;
determining an action request associated with the input;
querying a dynamic knowledge graph to determine whether the action request can be fully executed with the knowledge contained in the dynamic knowledge graph;
when it is determined that the action request cannot be fully executed with the knowledge contained in the dynamic knowledge graph:
requesting additional input;
automatically adding the additional input into the dynamic knowledge graph; and
executing the action request using the additional input.

10. The method of claim 9, wherein the additional input is an action.

11. The method of claim 9, wherein the additional input is an entity.

12. The method of claim 9, further comprising accessing a knowledge graph to obtain an entity or an action associated with the action request.

13. The method of claim 9, further comprising updating a confidence score of an action associated with the action request when the action request is fully executed.

14. The method of claim 9, further comprising updating a confidence score of an action associated with the action request when the action request cannot be fully executed.

15. The method of claim 14, further comprising executing one or more actions associated with the action request prior to requesting additional input when it is determined that the action request cannot be fully executed.

16. The method of claim 9, wherein querying a dynamic knowledge graph to determine whether the action request can be fully executed with the knowledge contained in the dynamic knowledge graph comprises indexing one or more actions and one or more entities contained in the knowledge graph.

17. A computer-readable storage medium storing computer executable instructions which, when executed by a processing unit, causes the processing unit to perform a method for updating dynamic knowledge graph, comprising:
receiving an input;
determining an intent of the input;
querying the dynamic knowledge graph to determine whether one or more actions within the dynamic knowledge graph can be executed to satisfy the intent of the input;
when it is determined that the dynamic knowledge graph does not include one or more actions to satisfy the intent of the input:
receiving additional input; and
automatically updating the dynamic knowledge graph with the additional input.

18. The computer-readable storage medium of claim 17, wherein the additional input is received from a third party application programming interface.

19. The computer-readable storage medium of claim 17, wherein the additional input is one of spoken input, text input, or touch input.

20. The computer-readable storage medium of claim 17, wherein querying the dynamic knowledge graph comprises indexing the dynamic knowledge graph.
